(19) United States
(12) Patent Application Publication
(10) Pub. No.: US 2023/0187733 A1
(43) Pub. Date: Jun. 15, 2023

(54) EQUALIZING TANK

(71) Applicant: MAHLE International GmbH, Stuttgart (DE)

(72) Inventors: Stefan Jauss, Donzdorf (DE); Michael Braunheim, Goeppingen (DE)

(21) Appl. No.: 18/078,086

(22) Filed: Dec. 8, 2022

(30) Foreign Application Priority Data
Dec. 9, 2021 (DE) 102021006067.9

(51) Int. Cl. H01M 10/6567; H01M 10/613

(52) U.S. Cl. CPC H01M 10/6567; H01M 10/613

(57) ABSTRACT

An equalizing tank for a cooling system of an electric battery for an electric drive train is disclosed. The equalizing tank includes a dimensionally stable housing having at least one opening that is connected to the cooling system of the battery. A flexible fluid-tight casing is arranged inside the housing and connected in a fluid-tight manner to the at least one opening such that a fluid can flow at least one of into and out of the flexible fluid-tight casing. The flexible fluid-tight casing being structured and arranged such that, depending on a degree to which the equalizing tank is filled with the fluid, the flexible fluid-tight casing rests against an inner wall of the housing.

### CROSS-REFERENCE TO RELATED APPLICATION

This application claims priority to German Application No. DE 10 2021 006 067.9 filed on Dec. 9, 2021, the contents of which are hereby incorporated by reference in its entirety.

### TECHNICAL FIELD

The present invention relates to an equalizing tank for a coolant system of a battery according. Further, the invention relates to a cooling system comprising an equalizing tank.

### BACKGROUND

DE 10 2019 214 755 A1 discloses a pressure equalizing tank for a battery system coolant with a diaphragm and a drying device to keep out possible moisture that may enter the system through the flow openings.

A disadvantage of this design is that an opening to the environment is required for pressure equalizing in the cooling system, through which moisture and dirt can enter the system. To prevent this, the design of the pressure equalizing tank is elaborate and complex, and yet it cannot completely rule out the possibility of dirt and moisture entering the system.

The present invention is therefore concerned with the problem of providing an improved or at least an alternative embodiment for an equalizing tank of the generic type, in particular to provide an equalizing tank with a simpler structure to both provide pressure equalizing for the system and to prevent moisture and/or dirt from entering the system.

According to the invention, this problem is solved by the subject matter of independent claim(s). Advantageous embodiments are the subject of the dependent claims.

### SUMMARY

The present invention is based on the general idea of providing an equalizing tank for a coolant system of a battery, which has a dimensionally stable housing consisting in particular of a plastic, in a particularly preferred embodiment a polyamide or a polypropylene. The properties of the plastics can be adapted to the application requirements, e.g. temperature resistance and pressure stability, by using additional fillers such as minerals, carbon black or glass fibers. In particular embodiments, the electrical conductivity can be influenced. In particular, fillers should be selected which do not increase the electrical conductivity. A dimensionally stable housing is understood to be a housing that is designed in such a way that, when the coolant system of a battery is operated as an equalizing tank, it does not undergo any significant change in shape despite high pressures of up to 4.5 bar and temperatures of between −40 and 90° C.

The housing has at least one opening which, in a preferred embodiment, may have a connecting piece to connect the equalizing tank to a cooling circuit of a directly cooled drive battery. A directly cooled drive battery is understood to be a battery that is in direct contact with the coolant of the cooling circuit and thus efficiently dissipates the heat of the battery. In a particularly preferred situation, the housing has openings, one of which is designed as an inlet opening and one of which is designed as an outlet opening. In a preferred embodiment, the openings comprise a valve, in particular a check valve.

A flexible fluid-tight casing is arranged inside the housing. A flexible fluid-tight casing is understood to be a container which is fluid-tight with respect to the fluid used, in particular a liquid fluid, in a particularly preferred embodiment an oil, and which, depending on the degree of filling, changes in such a way that it at least rests against a housing enclosing the casing or the casing at least partially collapses on itself. Here, in particular embodiments, the fluid-tight casing may be formed from a single or multi-layer material. Preferably, these materials are plastics, in particular polypropylene or polyamide, aluminum foil or fabric, in particular made of plastic or aluminum. The flexible fluid-tight casing is connected to the opening such that a fluid can flow into and/or out of the flexible fluid-tight casing via the opening. In a preferred embodiment, the flexible casing is welded to the housing in the area of the opening. In an alternative embodiment, the flexible casing is clamped between the opening of the housing and the connecting piece such that the flexible casing is held between the connecting piece and the opening and is also fluid tight with respect to the fluid flowing in and/or out.

The housing has an inner wall which, depending on the degree of filling, is at least partially in contact with the flexible fluid-tight casing. The inner wall can be planar or textured. In a preferred embodiment, the inner wall is textured, which prevents the flexible casing from sticking or adhering to the inner wall of the housing at higher temperatures and/or high pressures. Dimples have proven to be the preferred version of texturing. Dimples are understood to be semicircular elevations on the inner wall, which means that the flexible casing only rests against the semicircular elevations, the dimples, of the inner wall. As an alternative version of the texturing, grooving of the inner wall has also proven to be good, i.e. the inner wall has grooves.

Depending on the degree of filling of the equalizing tank, the flexible casing rests against the inner wall of the dimensionally stable housing. When there is a full degree of filling, the flexible casing is at least partially in contact with both the inner wall of the side walls and at least partially in contact with the inner wall of the top of the housing.

When the equalizing tank is half full, the flexible fluid-tight casing at least partially rests against the inner wall of the housing. When the equalizing tank is partially filled, the equalizing tank can be filled further via an increase in temperature and/or pressure, or fluid can be delivered to the cooling system and still be accommodated. Thus, the housing of the equalizing tank can compensate a possible increase in pressure and/or temperature and an associated expansion of the fluid in the cooling system.

When the equalizing tank is almost empty, the flexible fluid-tight casing only rests against the dimensionally stable housing in the area of the opening.

The advantage is that the temperature and/or pressure equalizing takes place in a completely closed system, which makes it possible for the first time to provide an equalizing system for a battery cooling system that has no opening to the environment and thus no contamination such as dust and/or moisture can enter the system.

By using the equalizing tank according to the invention in a cooling system of a battery, in particular for the use of a dielectric oil of a directly cooled battery, it is possible for the first time to provide a closed cooling system with an equalizing tank for a cooling system. This ensures that no moisture and/or dirt can enter the cooling system during operation and cause damage to the system or the battery.

The solution presented also makes it possible for the first time to provide a system that exhibits a lower pressure rise during operation, since the system equalizes the pressure via the flexible casing and does not have any additional valves for this purpose, which can lead to a pressure drop.

Further important features and advantages of the invention are apparent from the subclaims, from the drawings, and from the accompanying figure description based on the drawings.

It is understood that the above features and those to be explained below can be used not only in the combination indicated in each case, but also in other combinations or on their own, without departing from the scope of the present invention.

Preferred embodiments of the invention are shown in the drawings by way of example and will be explained in more detail in the following description, wherein identical reference signs refer to identical or similar or functionally identical elements.

### BRIEF DESCRIPTION OF THE DRAWINGS

It Shows, Each Schematically

FIG. 1 a schematic view of an equalizing tank according to the invention with a full degree of filling.

FIG. 2 a schematic view of an equalizing tank according to the invention with a half-full degree of filling

### DETAILED DESCRIPTION

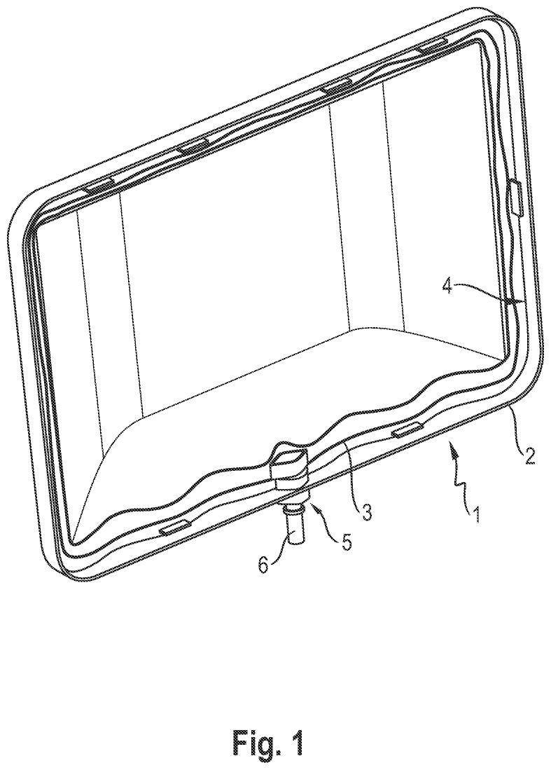

According to FIG. 1, the equalizing tank 1 according to the invention has a dimensionally stable housing 2, which is made in particular of a plastic, in a particularly preferred embodiment a polyamide or polypropylene. The housing has an opening 5, which may have a connecting piece 6 to connect the equalizing tank 1 to a cooling circuit of a fuel cell.

A flexible fluid-tight casing 3 is arranged inside the housing 2. The flexible fluid-tight casing 3 is connected to the opening 5 such that a fluid can flow into and/or out of the flexible fluid-tight casing 3 via the opening 5. In a preferred embodiment, the flexible casing 3 is welded to the housing 2 in the area of the opening 5. In an alternative embodiment, the flexible casing 3 is clamped between the opening 5 of the housing 2 and the connecting piece 6 such that the flexible casing 3 is held between the connecting piece 6 and the opening 5 and is also fluid-tight with respect to the fluid flowing in and/or out.

Depending on the degree of filling of the equalizing tank 1, the flexible casing 3 will lie against the inner wall 4 of the dimensionally stable housing 2. FIG. 1 shows a complete degree of filling, whereby the flexible casing 3 rests against the inner wall of the side walls as well as at least partially with the inner wall of the top of the housing.

In a preferred embodiment, the inner wall 4 has a textured design, which prevents the flexible casing 3 from sticking or adhering to the inner wall 4 of the housing 2 at higher temperatures and/or high pressures. Dimples have proven to be the preferred version of texturing. A dimple is understood to mean semicircular elevations on the inner wall 4, with which the flexible casing only rests against the semicircular elevations, the dimples, of the inner wall.

As an alternative version of the texturing, grooving of the inner wall has also proven to be good.

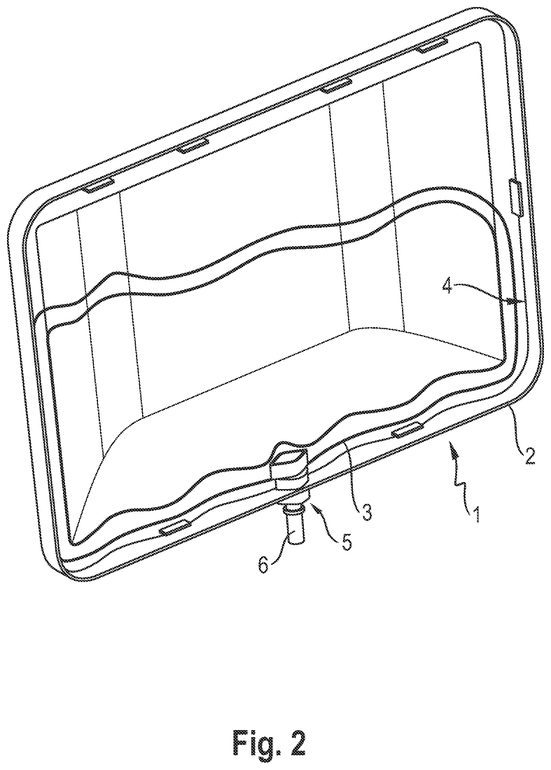

FIG. 2 shows a schematic view of the equalizing tank 1 according to the invention with a half-full degree of filling. At a half-full degree of filling, the flexible fluid-tight casing 3 at least partially rests against the inner wall 4 of the housing 2. The equalizing tank 1 of FIG. 2 also has, as already shown and listed in FIG. 1, a dimensionally stable housing 2 with an inner wall 4 and an opening 5, which in a preferred embodiment can have a connecting piece 6. All the features already listed in FIG. 1 are also applicable to the equalizing tank of FIG. 2.

In the state of partial filling of the equalizing tank 1, the equalizing tank 1 can be further filled via a temperature and/or pressure increase. The advantage is that the temperature and/or pressure equalizing takes place completely in the closed system, which makes it possible for the first time to provide an equalizing system 1 for a battery cooling system that has no opening to the environment and thus no contamination, such as dust and/or moisture, can enter the system.

1. An equalizing tank for an electric drive train, comprising:
a dimensionally stable housing having at least one opening, the at least one opening being connected to a cooling system of a battery,
a flexible fluid-tight casing arranged inside the housing and connected in a fluid-tight manner to the at least one opening such that a fluid can flow at least one of into and out of the flexible fluid-tight casing, the flexible fluid-tight casing being structured and arranged such that, depending on a degree of filling with the fluid, the flexible fluid-tight casing rests against an inner wall of the housing.

2. The equalizing tank according to claim 1, wherein the inner wall of the housing is planar and the flexible fluid-tight casing rests against the inner wall in a planar manner.

3. The equalizing tank according to claim 1, wherein the inner wall of the housing is textured.

4. The equalizing tank according to claim 3, wherein the inner wall of the housing comprises dimples and the flexible fluid-tight casing rests against at least a surface of the dimples.

5. The equalizing tank according to claim 3, wherein the inner wall of the housing is grooved.

6. The equalizing tank according to claim 1, wherein the flexible fluid-tight casing is a plastic composed of PE, PET, PA, AL or a mixture thereof.

7. The equalizing tank according to claim 1, wherein the housing is resistant and flexible in a temperature range from −50 to +140° C.

8. The equalizing tank according to claim 1, wherein the flexible fluid-tight casing is connected in a fluid-tight manner to the housing in an area of the at least one opening.

9. The equalizing tank according to claim 1, wherein the at least one opening of the housing has a separate connecting piece that is firmly connected to the housing.

10. The equalizing tank according to claim 9, wherein the flexible fluid-tight casing is clamped between the housing and the separate connecting piece such that the flexible fluid-tight casing is both fixed by the clamping and is fluid-tight.

11. The equalizing tank according to claim 1, wherein the housing is composed of polyamide.

12. A battery cooling system, comprising: an equalizing tank, the equalizing tank including:
a dimensionally stable housing having at least one opening, the at least one opening being connected to the battery cooling system;
a flexible fluid-tight casing arranged inside the housing and connected in a fluid-tight manner to the at least one opening such that a fluid can flow at least one of into and out of the flexible fluid-tight casing, the flexible fluid-tight casing being structured and arranged such that, depending on a degree to which the equalizing tank is filled with the fluid, the flexible fluid-tight casing rests against an inner wall of the housing.

13. The battery cooling system of claim 12, wherein the fluid is a dielectric oil.

14. The battery cooling system according claim 12, wherein the equalizing tank provides a closed system that is protected against ingress of at least one of water and dirt.

15. The battery cooling system according to claim 12, wherein the housing is a plastic housing.

16. The battery cooling system according to claim 12, wherein the inner wall of the housing is planar and the flexible fluid-tight casing rests against the inner wall in a planar manner.

17. The battery cooling system according to claim 12, wherein the inner wall of the housing is textured with a plurality of dimples and the flexible fluid-tight casing rests against the plurality of dimples.

18. The battery cooling system according to claim 12, wherein the inner wall includes a plurality of grooves.

19. The battery cooling system according to claim 12, wherein the flexible fluid-tight casing is welded to the housing in an area of the at least one opening.

20. The battery cooling system according to claim 12, wherein the at least one opening includes a separate connecting piece that is clamped, screwed, or clipped to the housing.
